(19) United States
(12) Patent Application Publication
(10) Pub. No.: US 2023/0411817 A1
(43) Pub. Date: Dec. 21, 2023

(54) WAVEGUIDE WITH TWO WAVEGUIDE SECTIONS

(71) Applicant: VEGA Grieshaber KG, Wolfach (DE)

(72) Inventors: Steffen WAELDE, Niedereschach (DE); Christian WEINZIERLE, Wolfach (DE)

(73) Assignee: VEGA Grieshaber KG, Wolfach (DE)

(21) Appl. No.: 18/338,035

(22) Filed: Jun. 20, 2023

(30) Foreign Application Priority Data
Jun. 20, 2022 (EP) 22179987.7

(51) Int. Cl. H01P 3/16; G01S 7/03

(52) U.S. Cl. CPC H01P 3/16; G01S 7/032

(57) ABSTRACT

A waveguide for propagating high frequency waves, a method of manufacturing a waveguide, and a waveguide assembly. The waveguide includes a first waveguide portion having a first material and a second waveguide portion having a second material, the second material having a higher temperature stability than the first waveguide portion. The waveguide assembly includes a dielectric waveguide and a temperature interface that includes the waveguide.

### CROSS-REFERENCE TO RELATED APPLICATIONS

This application claims the benefit of the filing date of European Patent Application No. 22 179 987.7 filed on 20 Jun. 2022, the entire content of which is incorporated herein by reference.

### FIELD

The disclosure relates to a waveguide for propagating radio frequency waves, a method of manufacturing a waveguide, a waveguide assembly, and a use.

### BACKGROUND

Various types of measuring instruments are used for fill level measurement or limit level determination, for example in a container. Devices that use high frequency waves (HF waves), in particular radar waves, for measurement are used for a variety of applications in automation technology, process monitoring and/or other fields of application. Particularly in fields of application where processes are monitored at very high temperatures, precautions must be taken to ensure that these devices can also be used at such high temperatures.

### SUMMARY

It is an object to provide a feature which permits the use of measuring instruments employing RF waves even at high temperatures. This task is solved by the subject matter of the independent patent claims. Further embodiments result from the sub-claims and the following description.

One aspect relates to a waveguide for propagating radio frequency waves, comprising waveguides:
a first waveguide section comprising a first material, and
a second waveguide section comprising a second material, the second material having a higher temperature stability than the first waveguide section.

Waveguides are suitable and/or configured to transmit RF waves, e.g., from an RF generator to an antenna. One embodiment of a waveguide is a dielectric waveguide. The dielectric waveguide may be designed, for example, as a plastic filament having a cross-sectional area of, in principle, any shape, which in at least some embodiments may be rectangular or circular. The dielectric waveguide may be suitable or adapted to transmit a high frequency signal, in particular to transmit a high frequency signal with low loss. For example, a dielectric waveguide may have a cross-sectional area between 0.25 mm² and 8 mm². The cross-sectional area may depend on the frequency of the measurement signal to be transmitted, the relative permittivity (DK value) of the material used, and/or the geometry of the cross-sectional area of the wave guide. In at least some cases, materials that exhibit low attenuation may be unsuitable for use at high temperatures. In this context, high temperatures are considered to be temperatures above 200° C., in particular above 300° C., for example above 400° C.

As an example of a material with low attenuation and limited temperature resistance, hard polyethylene (high density polyethylene, HDPE) may be considered, for example. For example, the tan(0) of HDPE in the range between 220 GHz and 330 GHz is 0.0016, which means that HDPE advantageously exhibits low attenuation. However, HDPE has a relatively low melting point, around 130° C. Similar may apply to other materials.

Furthermore, sensor electronics of the measuring device may be sensitive to high temperatures. For example, many semiconductors used as RF generators, as transmitters, as receivers and/or for other functions of the measuring device are specified only up to a maximum of about 85° C.

One of the measures or features that make it possible to use the measuring instruments even at high temperatures under the conditions mentioned is to make the distance between the RF generator and the antenna as long as possible. However, for measuring instruments whose use may make sense, the signal attenuation experienced by the RF signal during transmission must not be too high. Therefore, it is advantageous to use a waveguide with two waveguide sections, a first waveguide section having a first material and a second waveguide section having a second material, the second material having a higher temperature stability than the first waveguide section. Thus, the material facing the process has relatively higher temperature stability, and the material facing the electronics unit has relatively lower signal attenuation characteristics. In addition, the first material may be less expensive. In some embodiments, the second waveguide section may be suitable and/or configured for temperatures up to 450° C. For example, the length of the second waveguide section may be determined by its temperature coefficient. For example, the second section may have a length that allows—at a maximum permissible or specified temperature towards the process side—the other end of the second section to have a lower (in particular a significantly lower) temperature than the melting temperature of the first material. Such a waveguide with two waveguide sections therefore advantageously combines low attenuation of the RF signal with high temperature resistance.

In some embodiments, the first waveguide section and the second waveguide section are designed as a dielectric waveguide. Advantageously, this may be used, for example, to provide galvanic isolation between the sensor electronics and the antenna. A dielectric waveguide does not require any metallic connection for signal transmission, which may result in an excellent potential separation.

In some embodiments, the first waveguide section is a dielectric waveguide and the second waveguide section is a waveguide. Since a waveguide—usually metallic—may be suitable for very high temperatures, these embodiments may be particularly suitable for measurement devices specified for very high temperatures. In one embodiment, the waveguide sections may be implemented, for example, as a “waveguide—dielectric waveguide—waveguide” sequence.

In some embodiments, the first waveguide section has lower attenuation than the second waveguide section. This may be particularly advantageous for those embodiments that require a particularly large distance between the RF generator and the antenna.

In some embodiments, the first waveguide section is made of or comprises a plastic material, particularly a material selected from a group comprising polytetrafluoroethylene, PTFE, perfluoroalkoxy, PFA, polyvinylidene fluoride, PVDF, polypropylene, PP, polyoxymethylene, POM, polyethylene terephthalate, PET, polybutylene terephthalate, PBT, rigid polyethylene, HDPE.

In some embodiments, the second waveguide section, when configured as a dielectric waveguide, is made of or comprises a ceramic, particularly alumina or zirconia, or a plastic, particularly a material selected from a group comprising polyetheretherketone, PEEK, polyetherketones, PEK, polytetrafluoroethylene, PTFE, perfluoroalkoxy, PFA, and/or polyvinylidene fluoride, PVDF.

A number of considerations may be relevant when selecting materials for the first and/or second waveguide sections. The plastics, which may be used for waveguides, have different damping properties. For example, PTFE (polytetrafluoroethylene), PFA (perfluoroalkoxy), and HDPE (rigid polyethylene) have low damping properties. For example, the tan(0) of HDPE in the range between 220 GHz and 330 GHz is 0.0016, and the value of PTFE is even lower. Thus, from a high-frequency standpoint, a dielectric waveguide made of PTFE would be best suited for an RF measurement device. Unfortunately, both PTFE and PFA are plastics that contain fluorine, which makes them complex and expensive to manufacture. In contrast, it is possible to manufacture a waveguide inexpensively with HDPE using plastic injection molding, for example. However, HDPE has the disadvantage that it has a relatively low melting point (about 130° C.). Another possible material in the high-temperature range of RF antennas is polyetheretherketone (PEEK). PEEK melts at about 400° C. and may be used in environments from 300-325° C. without deforming. While PTFE may be used for temperatures up to 250° C., pressure and/or other mechanical stress on PTFE at this temperature may cause deformation. In the case of PEEK, its hardness allows it to be used in a high-stress, high-temperature environment without loss of molding properties. A disadvantage of PEEK is its relatively high loss angle tan(6), which ranges from 0.007 to 0.01 in a frequency range around 300 GHz. Therefore, a dielectric waveguide made of PEEK may be particularly suitable for temperature decoupling from a mechanical point of view, but it is reasonable to use a limited length of a second waveguide section made of PEEK due to the high high frequency losses. It should also be mentioned that ceramics may have an even higher temperature resistance than plastics.

In some embodiments, the second waveguide section, when configured as a waveguide, is made of or comprises metal, particularly copper, stainless steel, brass, or aluminum. Use of this combination of materials may advantageously provide a different compromise between signal attenuation and temperature resistance than other combinations of materials.

One aspect relates to a method of manufacturing a waveguide according to any one of the preceding claims, comprising the steps of:
providing a first waveguide section comprising a first material;
providing a second waveguide section comprising a second material, the second material having a higher temperature stability than the first waveguide section; and
connecting the first waveguide section to the second waveguide section by means of a form-fit, force-fit and/or material-fit connection, in particular an adhesive connection and/or ultrasonic welding.

Since the plastics of the first waveguide section and the second waveguide section may have different DK values, unfavorable reflections may occur in the case of a butt joint. For this case, so-called “matching areas” or “transition areas” may be provided. These areas are characterized by the fact that the transitions are designed in a special shape and/or by means of other features—e.g., by their joining technique—have a particularly low-reflection butt joint. For example, the transitions may be designed as a wedge, a cone and/or another bevel. Experiments have shown that bevels with an angle of between about 30° and 60°, e.g., of about 45°, to the central axis of the first and/or second waveguide section may have a particularly low reflection. It has also been shown that a welded or bonded joint may lead to relatively low reflections.

In some embodiments, the first waveguide section and the second waveguide section have a different cross-sectional area. For example, the second waveguide section may be thicker or thinner than the first section. The thickness of the respective waveguide may be matched to the relative permittivity of the plastic or ceramic used to ensure optimum propagation of the wave in terms of damping in the waveguide. The ratio of the cross-sectional area to the relative permittivity of the material determines the ratio of the field energies, i.e., how much of the electric field propagates inside and outside the waveguide. The more field propagates inside the material, the higher the signal attenuation. The more field propagates outside the material, the more sensitive the signal is to outside interference. It is therefore necessary to find an optimum compromise between the cross-sectional area and the material used.

In one embodiment, a two-piece waveguide is contained within a waveguide that acts, so to speak, as a third waveguide section.

One aspect relates to a waveguide arrangement. The waveguide arrangement comprises a dielectric waveguide as described above and/or below, and a temperature spacer comprising the waveguide. Advantageously, the temperature spacer may contribute to the waveguide arrangement and/or the measuring device having a particularly high temperature resistance.

In some embodiments, the intermediate temperature piece has cooling fins on an outer surface. This may contribute to a further increase of temperature resistance and/or to a particularly compact design of the waveguide arrangement and/or the measuring device.

One aspect relates to a radar apparatus, in particular to a radar fill level meter, comprising a waveguide or waveguide arrangement as described above and/or below.

One aspect relates to a use of a waveguide or waveguide arrangement as described above and/or below for propagating radar waves, in particular for frequencies between 70 GHz and 500 GHz, for example between 100 GHz and 300 GHz. For example, at frequencies in the range of about 100 GHz to 300 GHz, the antennas of the measurement devices may be made even smaller to obtain antenna gains comparable to those at 80 GHz. Smaller antennae also open up new fields of application in smaller containers or in factory automation. The semiconductor technology for such frequency ranges is freely commercially available on the market.

One aspect relates to a use of a waveguide or waveguide arrangement as described above and/or below for temperatures between −200° C. and 450° C., in particular for temperatures between −100° C. and 330° C. Advantageously, this allows process characteristics to be measured even at high process temperatures, even though the electronics of a measuring device are often specified only up to 85° C. Temperature decoupling between an RF generator and an antenna then takes place via the design of the waveguide or waveguide arrangement.

One aspect relates to a use of a radar apparatus as described above and/or below for fill level measurement, topology determination and/or limit level determination.

It should also be noted that the various embodiments described above and/or below may be combined.

For further clarification, the disclosure is described with reference to embodiments illustrated in the figures. These embodiments are to be understood only as examples and not as limitations.

### BRIEF DESCRIPTION OF THE FIGURES

Thereby Shows:

FIG. 1 schematically an RF measuring device according to an embodiment, which is arranged on a container;

FIG. 2 schematically an RF measuring device according to an embodiment;

FIGS. 3a, 3b, 3c and 3d schematically waveguides according to an embodiment.

### DETAILED DESCRIPTION OF EMBODIMENTS

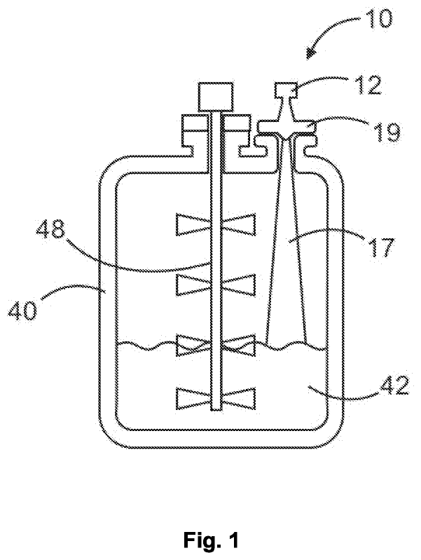

FIG. 1 schematically shows an RF measuring device 10 according to one embodiment, which is arranged on a container 40. The schematically shown container 40 may be, for example, a vessel or a measuring tank, process tank, storage tank or silo of any shape. The container 40 may be at least partially filled with a filling material 42. The fill material may be, for example, a liquid, including an emulsion or suspension, or a bulk material, particularly a granular or powdered bulk material, and/or some other type of medium or product.

For example, the RF measurement device 10 shown, which is configured for frequencies above 80 GHz, allows the use of smaller antenna designs and/or greater antenna gain for the same aperture than older devices that use frequencies of about 6 GHz. Advantageously, this allows quite small aperture angles of the main lobes 17 to be achieved, so that the antenna directivity patterns may be so small that interfering reflectors—such as agitators 48—no longer fall within the “view range” of the antenna 19, even in slim, tall vessels 40. For example, round horn antennas may be used as the antenna 19, which may, for example, in some embodiments, have a dielectric fill to reduce the length of the antenna horn.

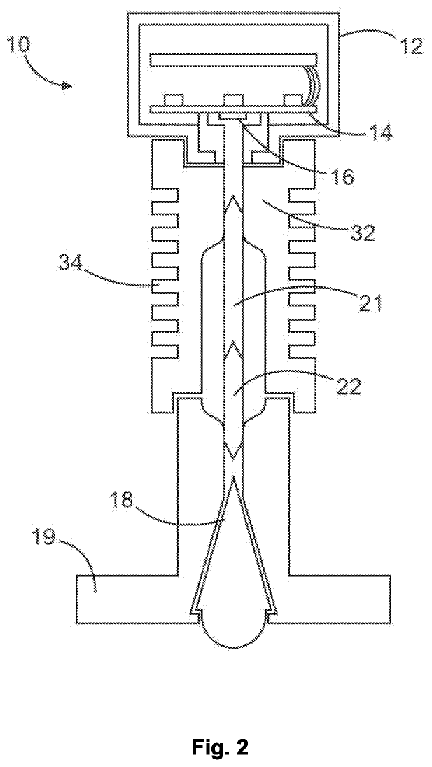

FIG. 2 schematically shows an RF measuring device 10, e.g., a radar measuring device, according to an embodiment. The RF measuring device 10 has a housing 12, in which a sensor electronics and a radar module 16, e.g., an RSoC, Radar System on Chip, are arranged. The radar module 16 is connected to an antenna 19 via a waveguide comprising a first waveguide section 21 and a second waveguide section 22. In one embodiment, the waveguide may comprise more than two sections. The antenna 19 is configured as a horn antenna 18 and has a filling 18 made of a dielectric material. The antenna 19 is oriented towards the process side, where the process may have high temperatures. For high temperature stability of the RF measurement device 10, the material of the second waveguide portion 22 has a higher temperature stability, temperature resistance or temperature stability than the first waveguide portion 21.

A waveguide may still be disposed between the second waveguide section 22 and the antenna 19.

To further increase the temperature stability, the RF measurement device 10 has a temperature intermediate piece 32 that includes the waveguide. The intermediate temperature piece 32 may have an internal cavity. Further, the intermediate temperature piece 32 may have cooling fins 34 on an outer surface.

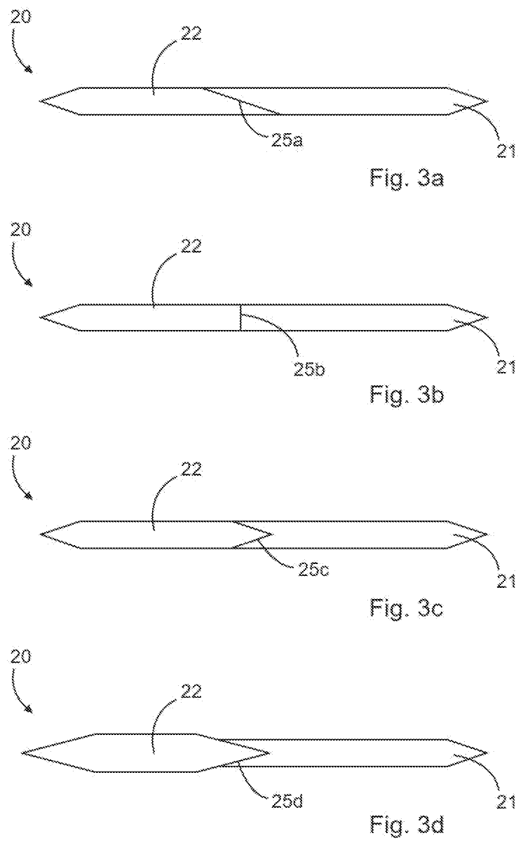

FIGS. 3a-3d schematically show waveguide 20 according to one embodiment. The wave guide 20 consists of a first waveguide section 21 and a second waveguide section 22. Since the plastics of the first waveguide section and the second waveguide section may have different DK values, unfavorable reflections may occur in the case of a butt joint (as shown, for example, in FIG. 3b). FIGS. 3a-3d show various embodiments for so-called “matching regions” or “transition regions” 25a-25d. The matching area 25a of FIG. 3a is designed as a wedge. The fitting area 25c of FIG. 3c or the fitting area 25d of FIG. 3d is designed as a cone. The fitting region may also be designed as another bevel. Experiments have shown that bevels with an angle between about 30° and 60°, e.g., of about 45°, to the central axis of the first and/or second waveguide section may be particularly low-reflection. It has also been shown that a welded or bonded joint may lead to relatively low reflections.

### LIST OF REFERENCE SIGNS

10 Radar apparatus
12 Housing
14 Sensor electronics
16 Wheel module
17 Main lobes
18 Antenna, horn antenna
19 Antenna system
20 dielectric waveguide
21 first waveguide section
22 second waveguide section
25a-25d Adjustment range
30 Waveguide arrangement
32 Temperature adapter
34 Cooling fins
40 Container
42 Fill material
48 Stirrer

1. A waveguide for propagating high frequency waves, the waveguide comprising:
a first waveguide section including a first material; and
a second waveguide section including a second material, the second material having a higher temperature stability than the first waveguide section.

2. The waveguide according to claim 1,
wherein the first waveguide section and the second waveguide section are each configured as a dielectric waveguide.

3. The waveguide according to claim 1,
wherein the first waveguide section is designed as a dielectric waveguide and the second waveguide section is designed as a metal waveguide.

4. The waveguide according to claim 1,
wherein the first waveguide section has a lower attenuation than the second waveguide section.

5. The waveguide according to claim 1,
wherein first waveguide section includes a plastic material.

6. The waveguide according to claim 1,
wherein second waveguide section, when designed as a dielectric waveguide, includes a ceramic or a plastic.

7. The waveguide according to claim 1,
wherein second waveguide section, when designed as a waveguide, includes metal.

8. A method of manufacturing a waveguide for propagating high frequency waves including a first waveguide section including a first material, and a second waveguide section including a second material, the second material having a higher temperature stability than the first waveguide section, comprising:
providing the first waveguide section having the first material;
providing the second waveguide section having the second material, the second material having the higher temperature stability than the first waveguide section; and
connecting the first waveguide section to the second waveguide section by way of a form-fit, force-fit, and/or material-fit connection.

9. The method of claim 8,
wherein a matching region is arranged between the first waveguide section and the second waveguide section, and/or
wherein the matching region is designed as a wedge or as a cone.

10. The method according to claim 8,
wherein the first waveguide section and the second waveguide section have a different cross-sectional area.

11. A waveguide assembly, comprising:
a dielectric waveguide according to claim 1, and
a temperature adapter including the dielectric waveguide.

12. The waveguide assembly according to claim 11,
wherein an intermediate temperature piece has cooling fins on an outer side.

13. A radar apparatus having the waveguide according to claim 1.

14. The waveguide according to claim 1, wherein first waveguide section includes a material from a group consisting of polytetrafluoroethylene (PTFE), perfluoroalkoxy (PFA), polyvinylidene fluoride (PVDF), polypropylene (PP), polyoxymethylene (POM), polyethylene terephthalate (PET), polybutylene terephthalate (PBT) and hard polyethylene (HDPE).

15. The waveguide according to claim 1,
wherein second waveguide section, when designed as a dielectric waveguide, includes a material selected from a group consisting of polyetheretherketone (PEEK), polyetherketones (PEK), polytetrafluoroethylene (PTFE), perfluoroalkoxy (PFA) and polyvinylidene fluoride (PVDF).

16. The waveguide according to claim 1,
wherein second waveguide section, when designed as a waveguide, includes a metal from a group consisting of copper, stainless steel, brass and aluminum.

17. The method of claim 8,
wherein the form-fit, the force-fit and the material-fit connection is an adhesive connection and/or an ultrasonic welding.

18. The method according to claim 9,
wherein the first waveguide section and the second waveguide section have a different cross-sectional area.

19. A radar fill level meter comprising:
the waveguide according to claim 1.

20. A radar apparatus comprising:
the waveguide assembly according to claim 11.
